(19) United States
(12) Patent Application Publication
(10) Pub. No.: US 2025/0365529 A1
(43) Pub. Date: Nov. 27, 2025

(54) Earpiece with Debris Ingress Protection

(71) Applicant: Bose Corporation, Framingham, MA (US)

(72) Inventors: Peter C. Santoro, Groton, MA (US); Timothy M. Parker, Marlborough, MA (US); Yaniv Eliezer Kaufman, Victoria (AU)

(21) Appl. No.: 19/215,661

(22) Filed: May 22, 2025

Related U.S. Application Data
(60) Provisional application No. 63/651,089, filed on May 23, 2024.

(51) Int. Cl. H04R 1/10

(52) U.S. Cl. CPC H04R 1/1091; H04R 1/1016; H04R 2460/01; H04R 2460/17

(57) ABSTRACT

Aspects include earpieces with debris ingress protection. The earpieces includes at least one feature for mitigating ingress of debris such as dust, dirt, wax, etc. In one example, an earpiece includes: an electro-acoustic transducer; a housing supporting the electro-acoustic transducer such that the housing and the electro-acoustic transducer together define a first acoustic volume, wherein the housing defines a nozzle with an acoustic passage coupled with the first acoustic volume; a first port coupling the first acoustic volume to a space outside the housing; a second port coupling a microphone supported in the housing to the space outside the housing; and an ear tip supported on the nozzle and configured to form a tight acoustic seal with a user's ear canal when the earpiece is worn, the ear tip comprising an extension member extending over the first port to inhibit debris from entering the first port.

### PRIORITY CLAIM

This application claims priority to U.S. Provisional Patent Application No. 63/651,089 (Earpiece with Debris Ingress Protection), filed May 23, 2024, the entire contents of which are hereby incorporated by reference.

### TECHNICAL FIELD

This disclosure relates to earpieces such as receiver-in-canal (RIC) earpieces. More particularly, the disclosure relates to earpieces for positioning in a user's ear.

### BACKGROUND

Earpieces that are placed in the canal can be prone to accumulation of debris, which negatively impacts acoustic performance and can cause undesirable acoustic artefacts.

### SUMMARY

Aspects include an earpiece with debris ingress protection. The earpiece includes at least one feature for mitigating ingress of debris such as dust, dirt, wax, etc.

Various implementations include an earpiece comprising: an electro-acoustic transducer; a housing supporting the electro-acoustic transducer such that the housing and the electro-acoustic transducer together define a first acoustic volume, wherein the housing defines a nozzle with an acoustic passage coupled with the first acoustic volume; a first port coupling the first acoustic volume to a space outside the housing; a second port coupling a microphone supported in the housing to the space outside the housing; and an ear tip supported on the nozzle and configured to form a tight acoustic seal with a user's ear canal when the earpiece is worn, the ear tip comprising an extension member extending over the first port to inhibit debris from entering the first port.

Various additional implementations include an earpiece comprising: an electro-acoustic transducer; a housing supporting the electro-acoustic transducer such that the housing and the electro-acoustic transducer together define a first acoustic volume, a first port coupling the first acoustic volume to a space outside the housing; a second port coupling a microphone supported in the housing to the space outside the housing; and a plate extending along the housing, the plate including a mesh covered opening positioned over the first port to inhibit debris from entering the first port.

Various further implementations include an earpiece comprising: an electro-acoustic transducer; a housing supporting the electro-acoustic transducer such that the housing and the electro-acoustic transducer together define a first acoustic volume, a first port coupling the first acoustic volume to a space outside the housing; a second port coupling a microphone supported in the housing to the space outside the housing; and a plate extending along the housing, the plate including a mesh covered opening positioned over the second port to inhibit debris from entering the second port.

Various additional implementations include an earpiece comprising: an electro-acoustic transducer; a housing supporting the electro-acoustic transducer such that the housing and the electro-acoustic transducer together define a first acoustic volume, a first port coupling the first acoustic volume to a space outside the housing; a second port coupling a microphone supported in the housing to the space outside the housing, wherein the second port is located on a rear surface of the housing; and a removable wax guard in the second port to inhibit debris from entering the second port.

Various further implementations include an earpiece comprising: an electro-acoustic transducer; a housing supporting the electro-acoustic transducer such that the housing and the electro-acoustic transducer together define a first acoustic volume, a first port coupling the first acoustic volume to a space outside the housing; a second port coupling a microphone supported in the housing to the space outside the housing; and a sleeve at least partially surrounding the housing to inhibit debris from entering at least one of the first port or the second port.

All examples and features mentioned below can be combined in any technically possible way.

In some cases, the extension member includes at least one aperture that acoustically couples the first port with the space outside the housing.

In certain aspects, the extension member includes a plurality of apertures.

In some cases, at least one of the plurality of apertures is offset from the first port.

In some cases, the offset aperture mitigates debris entering the first port.

In some cases, the extension member is integral with the ear tip.

In some cases, the extension member includes at least one tab contacting an outer surface of the housing to create an acoustic passage between the extension member and the housing.

In some cases, the at least one tab extends from an inner surface of the extension member to contact the outer surface of the housing.

In some cases, the acoustic passage between the extension member and the housing maintains an acoustic coupling between the first acoustic volume and the space outside the housing.

In some cases, the ear tip is removable from the housing.

In some cases, the microphone includes a feedforward microphone acoustically coupled with the second port.

In some cases, the second port is located on a rear surface of the housing.

In some cases, the earpiece further includes wiring extending from the rear surface of the housing for connecting with a behind-the-ear module of an audio device that includes the earpiece.

In some cases, the earpiece further includes a cover over the second port to inhibit debris from entering the second port.

In some cases, the cover includes at least one aperture that acoustically couples the second port with the space outside the housing.

In some cases, the cover includes a plurality of apertures.

In some cases, at least one of the plurality of apertures is offset from the second port.

In some cases, the offset aperture mitigates debris entering the second acoustic volume.

In some cases, the housing includes a recess along the rear surface, and the cover complements the recess along the rear surface.

In some cases, the cover is removably coupled with the rear surface at the recess.

In some cases, the earpiece further includes: a first magnet in the housing, wherein the cover includes a metal that is retained by a magnetic force from the first magnet.

In some cases, the cover is removable by a tool.

In some cases, the tool includes a second magnet having a greater magnetic strength than a magnetic strength of the first magnet.

In some cases, a hearing aid includes the earpiece.

In some cases, the hearing aid further includes a behind-the-ear module coupled with the earpiece by a wire.

In some cases, the earpiece further includes a recess in a sidewall of the housing, the recess complementing the plate.

In some cases, the mesh covered opening is oversized relative to the first port.

In some cases, the plate includes a metal.

In some cases, the earpiece further includes at least one magnet within the housing for retaining the metal plate with a magnetic force.

In some cases, the plate is removable by a tool.

In some cases, the tool includes an additional magnet having a greater magnetic strength than a magnetic strength of the at least one magnet in the housing.

In some cases, the plate includes at least one recess to enable at least one of coupling or decoupling of the plate from the housing.

In some cases, the plate defines a radial gap between an inner surface of the plate and an outer surface of the housing, the radial gap acting as an acoustic passage between the first port and the at least one recess.

In some cases, the plate is removably coupled with the housing.

In some cases, the mesh covered port includes a mesh with a Rayl value of approximately 6.

In some cases, the Rayl value enables approximate acoustic transparency while blocking debris.

In some cases, the microphone includes a feedforward microphone acoustically coupled with the second port, wherein the second port is located on a rear surface of the housing.

In some cases, the earpiece further includes a recess in a sidewall of the housing, the recess complementing the plate.

In some cases, the mesh covered opening is oversized relative to the second port.

In some cases, the plate includes a metal.

In some cases, the earpiece further includes at least one magnet within the housing for retaining the metal plate with a magnetic force.

In some cases, the plate is removable by a tool.

In some cases, the tool includes an additional magnet having a greater magnetic strength than a magnetic strength of the at least one magnet in the housing.

In some cases, the plate includes at least one recess to enable at least one of coupling or decoupling of the plate from the housing.

In some cases, the plate defines a gap between an inner surface of the plate and an outer surface of the housing, the gap acting as an acoustic passage between the second port and the at least one recess.

In some cases, the second port is located on a rear surface of the housing.

In some cases, the second port is located on a side surface of the housing, and wherein the plate extends to a rear surface of the housing.

In some cases, the removable wax guard includes at least one aperture that acoustically couples the second port with the space outside the housing.

In some cases, the sleeve extends along a length of the housing.

In some cases, the sleeve is formed of a compliant material.

In some cases, the compliant material includes silicone.

In some cases, the sleeve has a thickness of less than approximately 0.2 to approximately 0.6 millimeters, e.g., less than approximately 0.4 mm.

In some cases, the sleeve includes a plurality of apertures for acoustically coupling the first port and/or the second port with the space outside the housing.

In some cases, the sleeve includes at least one alignment feature for circumferentially aligning the sleeve to the first port and/or the second port.

In some cases, the sleeve includes two distinct sets of apertures for respectively aligning with the first port and the second port.

In some cases, the housing and the electro-acoustic transducer together define a second acoustic volume, the electro-acoustic transducer being arranged such that a first radiating surface of the transducer radiates acoustic energy into the front acoustic volume and such that a second radiating surface of the transducer radiates acoustic energy into the second acoustic volume.

In some cases, the microphone and/or second port are not necessarily coupled to either acoustic volume.

Two or more features described in this disclosure, including those described in this summary section, may be combined to form implementations not specifically described herein.

The details of one or more implementations are set forth in the accompanying drawings and the description below. Other features, objects and benefits will be apparent from the description and drawings, and from the claims.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples, and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a perspective view of an example hearing aid according to various implementations.

FIG. 2 is a schematic view illustrating an example earpiece according to various implementations.

FIG. 3 shows a perspective view of an earpiece including an eartip according to various implementations.

FIG. 4 is shows a perspective view of an earpiece with a first port according to various implementations.

FIG. 5 is a schematic view illustrating acoustic volumes and ports in an earpiece according to various implementations.

FIG. 6 is a perspective view of an earpiece with an ingress protection feature according to various additional implementations.

FIG. 7 is a perspective end view of the earpiece of FIG. 6, according to various implementations.

FIG. 8 is a perspective view of an additional earpiece with an ingress protection feature according to various implementations.

FIG. 9 is a perspective view of another earpiece with an ingress protection feature according to various implementations.

FIG. 10 shows an additional earpiece with an ingress protection feature according to various implementations.

FIG. 11 illustrates an ingress protection sleeve on an earpiece according to various implementations.

FIG. 12 shows an ingress protection sleeve removed from an earpiece according to various additional implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

Various disclosed implementations include earpieces such as receiver-in-canal (RIC) earpieces. Particular implementations relate to earpieces for positioning in a user's ear. In various implementations, the earpieces include a housing with a set of ports (e.g., two or more ports), and a debris ingress mitigation feature. In some examples, each of the ports has a debris ingress mitigation feature. In additional examples, one or more of the ports has a debris ingress mitigation feature. In certain implementations, the debris ingress mitigation feature is configured to couple with the housing. In some implementations, the debris ingress mitigation feature is removably coupled with the housing, e.g., to enable replacement and/or cleaning.

Certain conventional earpieces, such as receiver-in-canal (RIC) earpieces include one or more ports that can be susceptible to debris ingress, which can detract from acoustic performance and/or cause undesirable acoustic artefacts (e.g., squealing or other such sounds). In particular implementations, ports along one or more portions of the earpiece housing are susceptible to debris ingress. In some cases, debris includes dust, dirt, and/or earwax.

Examples of the earpieces and acoustic assemblies (e.g., hearing aids) described herein are not limited in application to the details of construction and the arrangement of components set forth in the following description or illustrated in the accompanying drawings. The acoustic assemblies are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the devices herein referred to in the singular may also embrace embodiments including a plurality, and any references in plural to any example, component, element, act, or function herein may also embrace examples including only a singularity. Accordingly, references in the singular or plural form are not intended to limit the presently disclosed devices, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

Commonly labeled components in the FIGURES are considered to be substantially equivalent components for the purposes of illustration, and redundant discussion of those components is omitted for clarity.

Various disclosed implementations relate to earpieces in audio devices such as hearing aids (or, hearing aids) and other modular acoustic assemblies, certain aspects of which are described in U.S. Pat. No. 11,234,085 (“Earpieces and Related Articles and Devices” issued Jan. 25, 2022) and U.S. patent application Ser. No. 17/446,896 (“Hearing Assistance Devices and Methods of Generating a Resonance Within a Hearing Assistance Device” filed Sep. 3, 2021), each of which is entirely incorporated by reference herein. Further example embodiments of earpieces are described in U.S. patent application Ser. No. 17/670,046 (“Earpieces,” filed Feb. 11, 2022) and U.S. patent application Ser. No. 16/990,358 (“Earpiece Porting,” filed Aug. 11, 2020), each of which is entirely incorporated by reference herein.

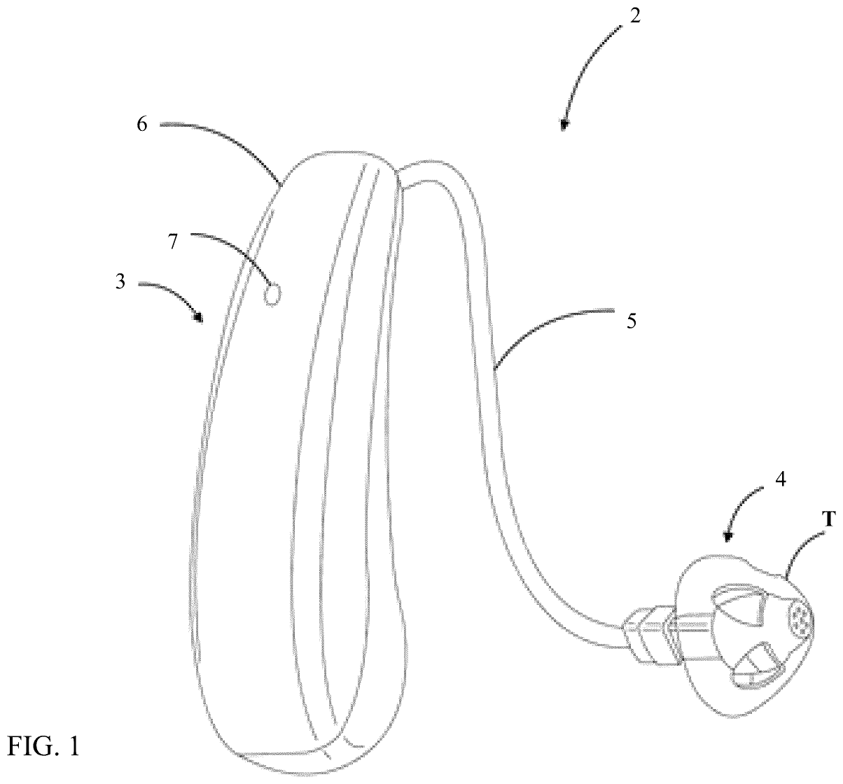

The term “hearing assistance device” or “hearing aid” as used in this disclosure, in addition to including its ordinary meaning or its meaning known to those skilled in the art, is intended to mean a device that fits around, on, in, or near an ear (including open-ear audio devices worn on the head or shoulders of a user) and that radiates acoustic energy into or towards the ear. A hearing assistance device includes an acoustic driver to transduce audio signals to acoustic energy. The acoustic driver can be housed in an earcup, earbud, or other portion of the hearing assistance device that sits within the user's ear canal during operation. While some of the figures and descriptions following can show a single hearing assistance device, a pair of hearing assistance devices can be provided, each having a respective portion that sits within the user's ear canal. Additionally, each hearing assistance device can be connected mechanically to another hearing assistance device or headphone, for example by a headband and/or by leads that conduct audio signals to an acoustic driver in the hearing assistance device or headphone. Further, as described herein, hearing assistance devices can include components for wirelessly receiving audio signals. A hearing assistance device can also include components of an active noise reduction (ANR) system. Hearing assistance devices can also include other functionality such as a microphone so that they can function as a headset. While FIG. 1 shows and example of a behind-the-ear form factor, in other examples the hearing assistance device can be an on-ear, around-ear, in-ear, or near-ear headset.

FIG. 1 is a front perspective view of an audio device (e.g., hearing aid, or hearing assistance device) 2 according to the present disclosure. Audio device 2 includes a control module 3 and a driver module 4. In a particular example, the control module 3 is a behind-the-ear (BTE) module and the driver module 4 is a first receiver-in-canal (RIC) module. The driver module 4 is also referred to as an “earpiece” herein, and is configured to be placed in or proximate the user's ear canal.

During operation of the audio device 2, the control module (or, behind-the-ear portion) 3 is configured to secure to or mount behind a user's ear, while the earpiece (or RIC portion) 4 is configured to sit within a user's ear canal. BTE portion 3 is communicably coupled or in electrical communication with the earpiece 4 via one or more wires 5. As discussed herein, audio signals and/or electrical signals processed or utilized by BTE portion 3 or earpiece 4 are transported via the one or more wires (or, interconnects) 5 in the generation of audible acoustic energy proximate the user's ear canal. In certain implementations, the wire(s) 5 is referred to as an interconnect, and it is understood that any configuration capable of physically connecting BTE portion 3 and earpiece 4 can be used in accordance with various disclosed implementations. In certain implementations, the interconnect 5 is integral with the BTE portion 3, but can be removably (or, modularly) coupled with the earpiece 4.

As illustrated in this example, earpiece 4 includes a deformable tip T configured to engage with at least a portion of the user's ear or ear canal. Although illustrated as an open deformable tip, e.g., a deformable tip with one or more holes, it should be appreciated that tip T can be a closed tip, e.g., where tip T includes no holes and the surface of tip T is configured to engaged with the user's ear canal so as to form an acoustic seal against and with the user's ear canal. In some examples, tip T is arranged on a nozzle of a second housing of the earpiece 4. Throughout the present disclosure, reference is made to an audio device 2 such as a hearing aid; however it should be appreciated that the principles discussed herein, i.e., modular components and related control approaches, can be implemented in other audio devices, e.g., earbuds, headsets, headphones, sport headphones, audio eyeglass form factor devices, whether they are wired or wireless. Further, such principles can be applied to other audio systems with modular components, e.g., vehicle (e.g., automobile) audio systems and/or home audio systems.

The BTE portion 3 is shown including a housing 6, which can include one or more external microphones 7 in some implementations. External microphone(s) 7 is positioned within first housing 6 and configured to receive acoustic energy from outside of first housing 6 of BTE portion 3 coming from the environment surrounding the user. External microphone 7 can also be used in the active noise reduction or active noise cancellation functionality of audio device 2. In certain cases, the BTE portion 3 has circuitry that includes an ANR device including a configurable digital signal processor (DSP), which can be used for implementing various signal flow topologies and filter configurations. Examples of such DSPs are described in U.S. Pat. Nos. 10,580,398; 8,073,150; and 8,073,151, each which is hereby incorporated herein by reference in its entirety.

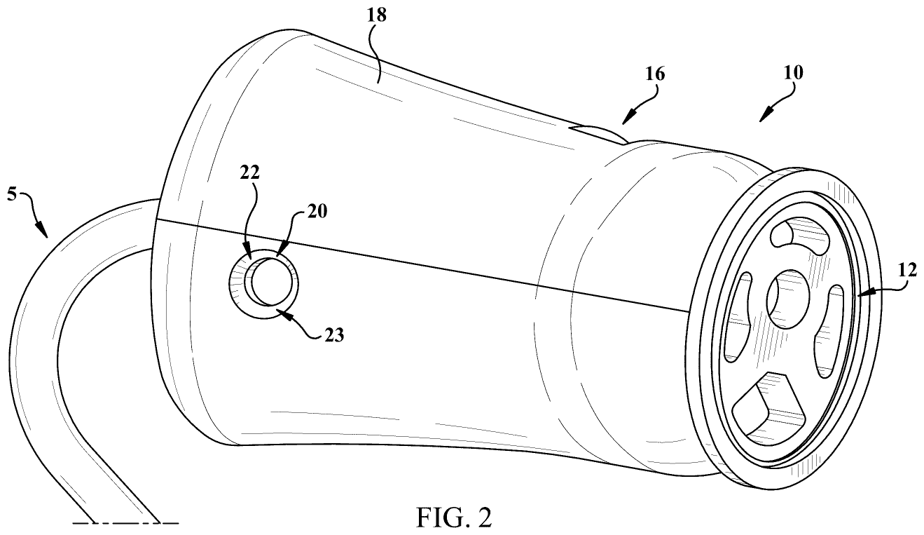

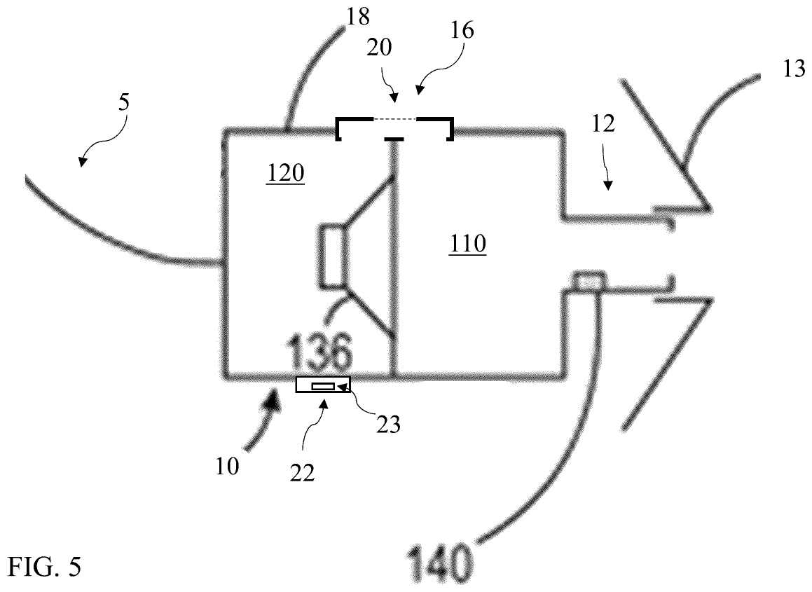

FIGS. 2-4 shows schematic depictions of an example earpiece 4 according to various implementations. The earpiece 4 can include a receiver in canal (RIC) earpiece 10 according to various implementations. A schematic depiction of an example interior of the earpiece 4 is depicted in FIG. 5.

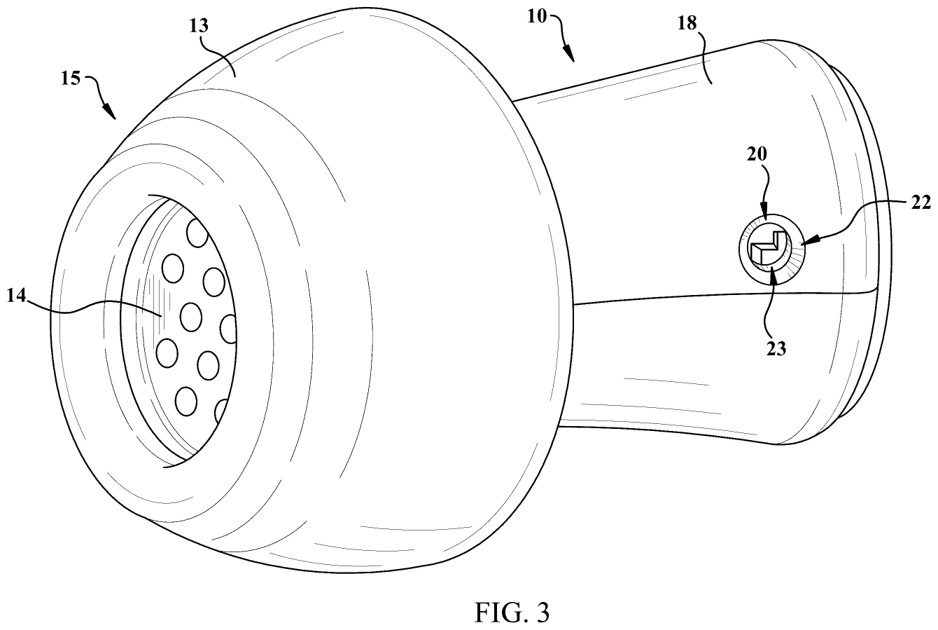

With reference to FIGS. 2-5, the earpiece 10 can include a nozzle 12, which can be protected by the dome 13 (FIG. 3) in an eartip 15 of a housing 18. In some cases, the eartip 15 includes a mesh 14 (FIG. 3) that protects the nozzle 12, e.g., from debris ingress. In some aspects, the eartip 15 forms a tight acoustic seal with a user's ear canal when the earpiece 10 is worn. In particular cases, the housing 18 has a first port 16, e.g., an exit port coupled with one or more acoustic volumes 110, 120 in the housing 18 (FIG. 5). With reference to FIG. 5, in various implementations, the acoustic volumes are located in front of (110) and behind (120), respectively, a transducer 136. In some cases, the transducer 136 includes an electro-acoustic transducer, however, other types of transducers are possible according to various implementations. In some cases, as noted herein, the first port 16 is acoustically coupled with one or both of the acoustic volumes 110, 120. In other cases, the acoustic port 16 is coupled with various additional volumes and/or sub-volumes in the housing 18 such as shown and described in U.S. patent application Ser. No. 16/990,358 (previously incorporated by reference herein).

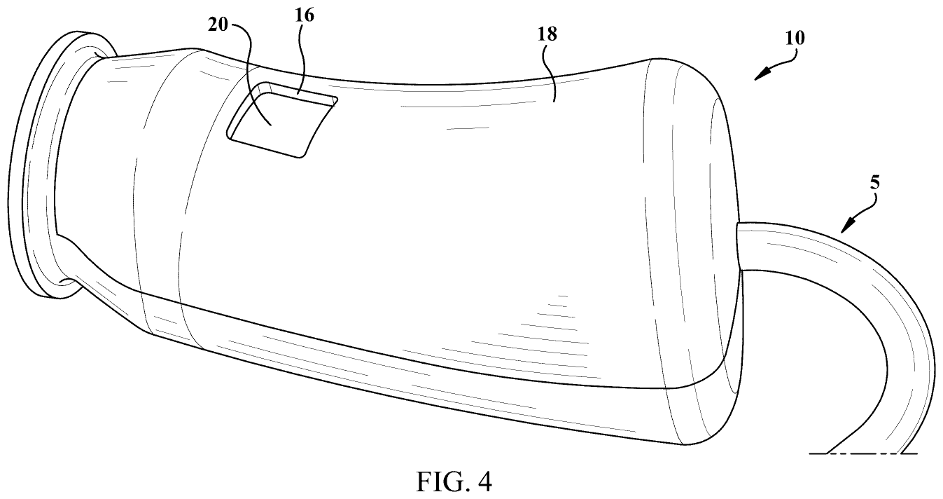

In one example, the first port 16 is coupled with both acoustic volumes 110, 120 in the housing 18, and can be referred to as a shared exit port. In particular cases, the first port 16 is the location in which a pressure equalization (Peq) port and a mass port come together before exiting the RIC housing 18. In some cases, the first port 16 is covered with a mesh 20 (FIG. 4), which can be used to mitigate debris ingress. In certain examples, the meshes described herein (e.g., mesh 20) can have a Rayl value that enables approximate acoustic transparency while blocking debris, e.g., a Rayle value of approximately 6. In additional cases, the housing 18 includes is a second port 22, which in particular cases, houses a feedforward (FF) microphone 23. In certain cases, the second port 22 is referred to as a FF microphone port 22. In particular cases, the second port 22 is also covered with a mesh 20, however, this is optional in certain implementations. In certain implementations, a portion of the second port 22 can be covered with a shield such as a metal and/or plastic shield. In some examples, the second port 22 includes a metal (e.g., stainless steel) cover around at least a portion thereof, e.g., for holding mesh 20. In other examples, the second port 22 includes a plastic cover around at least a portion thereof (e.g., including a metal insert and/or a bonded magnet), which can be coupled with (or retain) an insert housing the mesh 20, e.g., a metal insert or a bonded magnet. Additional implementations can also include a feedback microphone 140, as illustrated in FIG. 5. However, certain implementations including a feedback microphone 140 are optional.

In certain cases, even with mesh 20 in place, debris (e.g., dust, dirt, ear wax, etc.) can enter the first port 16 and/or second port 22. Over time, this debris can block at least a portion of the acoustic passage through port(s) 16 and/or 22. For example, debris in the first port 16 can cause a blockage that negatively impacts device performance. For example, in earpieces such as earpiece 10 that includes active noise reduction (ANR) or active noise cancelation (ANC) capabilities, blockage in the first port 16 can push the ANR system toward instability, leading, for example, to undesirable acoustic artefacts such as squealing sounds. Further, blockage in the second port 22 (including a feedforward microphone 23) can impact performance, for example, detracting from ANR performance by as much as 10 decibels (dB).

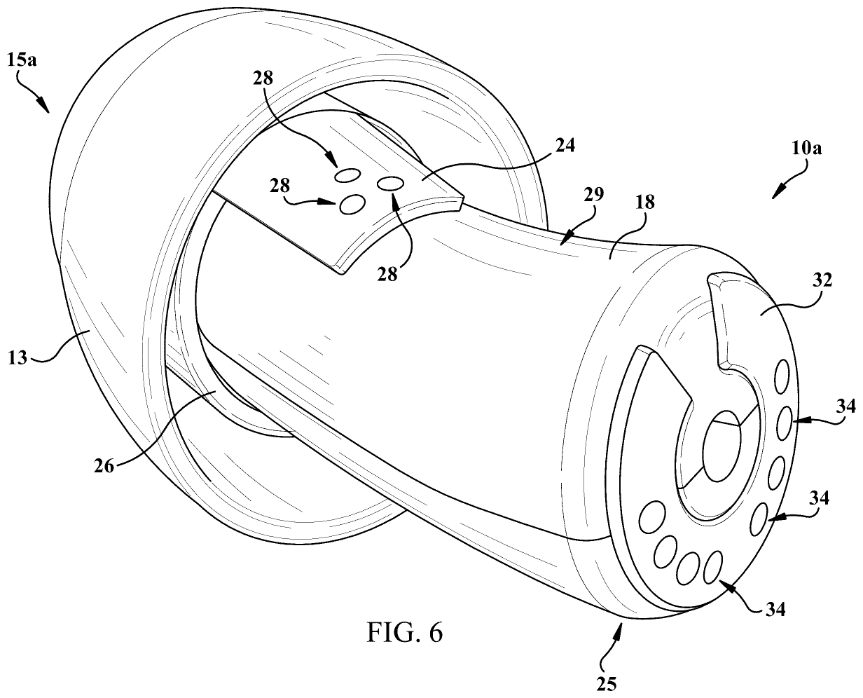

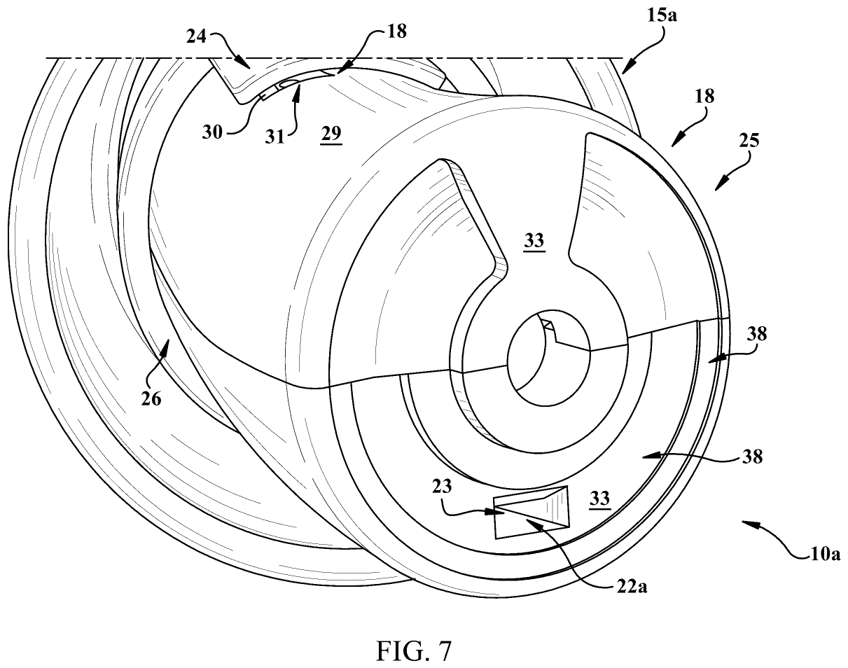

FIGS. 6 and 7 shows another implementation of an earpiece 10a according to various implementations. Earpiece 10a can include certain common features with earpiece 10, redundant explanation of which is omitted. In a particular implementation, the earpiece 10a includes one or more debris mitigation or debris resistance features to protect one or more ports (e.g., first port 16 and/or second port 22). Certain of these debris mitigation/resistance features can be removably coupled with the housing 18 to enable cleaning, maintenance, and/or replacement thereof.

In a first example shown in FIGS. 6 and 7, an eartip 15a is shown including extension member 24. As with other eartips described herein, eartip 15a can be removable from housing 18. In certain implementations, when the eartip 15a is mounted on the nozzle 12, the extension member 24 extends out from a collar 26 of the eartip 15a to inhibit debris from entering the first port 16. In particular cases, while the eartip 15a is mounted on the nozzle 12, the extension member 24 overlies and protects the first port 16 from debris ingress. In certain implementations, the extension member 24 includes a flap of material that extends axially from the collar 26 toward the back of the housing 18 (e.g., back or rear end 25 of the housing 18). In a particular implementation, the extension member 24 is integral with the eartip 15a, and in more particular cases, is formed of a common material and/or in a common manufacturing process.

In some cases, at least one aperture 28 is provided in the extension 24 to assist in acoustically coupling the exit port 16 to the outside of the housing 18. In a particular example, the extension member 24 includes a plurality of apertures 28. In certain examples, at least one of the apertures 28 is offset from the first port 16. For example, one or more apertures 28 is not aligned with the first port 16. In some cases, all apertures 28 are misaligned with the first port 16, such that none of the apertures 28 has a common center point (or central axis) with a center point or central axis of the first port 16. In certain cases, the offset nature of the apertures 28 can mitigate debris entering the first port 16.

As can be seen in FIG. 7, in some cases, the extension member 24 also includes at least one tab (e.g., standoff) 30 that contacts an outer surface 29 of the housing 18 to create an acoustic passage 31 between the extension member 24 and the housing 18. In certain cases, the tab(s) 30 sit between an inner surface of the extension member 24 and the outer surface 29 of the housing 18. In particular cases, the acoustic passage 31 maintains an acoustic coupling between the first acoustic volume 110 and the space outside the housing 18. In other terms, the acoustic passage 31 creates another path for airflow to ensure that first port 16 remains acoustically coupled to the space outside the housing 18 even if the aperture(s) 28 in the extension member 24 become occluded.

In further implementations, as noted herein, a second port 22a can be acoustically coupled with a feedforward microphone, e.g., feedforward microphone 23. In particular cases, the port 22a is located on a rear surface 33 of the housing 18. In certain cases, the rear surface 33 is the location of the connecting wire 5 (FIGS. 1, 2, 5) for connecting with the behind-the-ear module 3 (FIG. 1). In particular cases, a cover (or, rear cover) 32 (FIG. 6) is positioned over port 22a to inhibit debris from entering port 22a. In other terms, the cover 32 can overlie and protect the port 22. In some cases, the rear cover 32 includes at least one aperture 34, and in particular non-limiting examples, includes a plurality of apertures 34 that acoustically couple the second port 22a with the space outside the housing 18. In certain cases, one or more of the apertures 34 is offset from the second port 22a (e.g., having respective center points or center axes that are not aligned). As noted above regarding other apertures, the offset nature of apertures 34 relative to port 22a can mitigate debris entering the port 22a during use. In particular cases, apertures 34 are acoustically coupled to the second port 22a via a channel 36 formed in the RIC housing 18, e.g., in the rear surface 33. In particular implementations, the channel 36 extends from the second port 22a, and defines a space behind the cover 32 that defines an acoustic passage between the second port 22a and at least one of the apertures.

In some cases, the cover 32 sits in a recess 38 in the housing 18, which in some cases complement one another. In particular cases, the cover 32 is held in place by magnets (not shown) disposed in the housing 18 (e.g., mounted internal to the housing 18 and/or on the body of housing 18). In some aspects, the cover 32 is formed of a plastic, composite, or other material, and is configured for a force or pressure fit in the recess 38. In particular cases, cover 32 is made of metal and can be removed by a magnetic tool. In some cases, the magnetic tool has a greater magnet strength than is provided by the magnet(s) in the housing 18, e.g., enabling efficient removal by a user. In certain implementations, if the apertures 34 become occluded with debris (e.g., with dust, dirt, earwax, etc.), the cover 32 can be removed and cleaned and/or replaced.

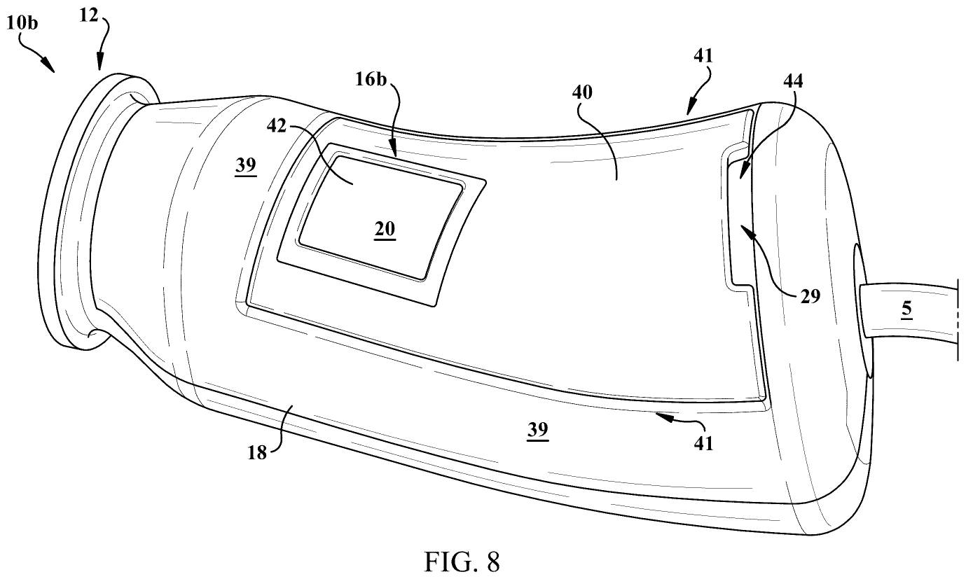

FIG. 8 shows another earpiece 10b according to various implementations. Earpiece 10b can include various features that are common with earpiece(s) 10 and 10a, redundant explanation of which is omitted. In some cases, earpiece 10b is well suited to protect (e.g., prevent debris ingress into) a first port 16b located along a sidewall 39 of the housing 18. In some cases, a plate 40 extends along the housing 18 (e.g., along sidewall 39 of housing), and is removably coupled with the housing 18. In some cases, the plate 40 includes a metal. In other cases, the plate includes a plastic, composite, or other material that is configured to fit in a recess 41 in the sidewall 39. In certain cases, the plate 40 includes a mesh covered opening 42 (housing mesh 20) that is arranged to overlie the exit port 16. In particular cases, the mesh covered opening 42 is oversized relative to the first port 16b that it covers. In some examples, the mesh 20 in mesh covered opening 42 has a Rayl value of approximately 6, e.g., enabling approximate acoustic transparency while blocking debris.

In cases where the plate 40 includes a metal, that metal plate 40 can be coupled to the housing 18 (e.g., at recess 41) via one or more internal magnets. This magnet attachment can allow the metal plate 40 to be removed for cleaning or replacement if the mesh 20 becomes occluded, e.g., by a magnetic tool such as described with respect to earpiece 10a.

In some cases, the plate 40 complements the recess 41 in the sidewall 39. In some cases, the plate 40 includes recess 44 to enable coupling and/or decoupling of the plate 40 from the housing 18. For example, the recess 44 can enable a user's finger, fingernail or a tool to be used to remove the plate 40 from the recess 41 in sidewall 39, e.g., for cleaning and/or replacement. In certain cases, the plate 40 defines a radial gap between an inner surface of the plate (not shown) and an outer surface 29 of the housing 18. In various implementations, the radial gap acts as an acoustic passage between the first port 16b and the recess 44. Further, because the recess 44 is separated (e.g., along the length of the sidewall 39) from the first port 16b, it is less likely to become obstructed with debris.

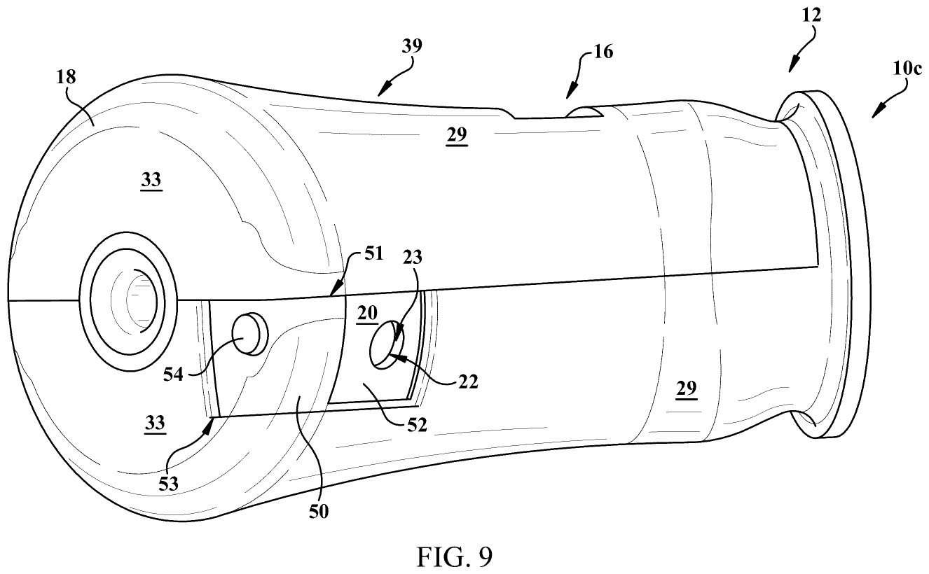

FIG. 9 shows another implementation of an earpiece 10c. Features of the earpiece 10c may be compatible with any other implementation of earpiece herein, for example, earpiece 10b. In such cases, features of the earpiece 10c (e.g., protecting second port 22) can be combined with the features of earpiece 10b (e.g., protecting first port 16). As noted herein, the second port 22 can include a feedforward microphone 23 in various implementations. In particular cases, the feedforward microphone enables active noise reduction (ANR) functionality in the earpiece 10c.

In some cases, earpiece 10c includes a plate 50 that is removably coupled with the housing 18. In certain aspects, the plate 50 has a mesh covered opening 52 that extends along housing 18. In particular cases, the mesh covered opening 52 is positioned over the second port 22 to inhibit debris from entering that port 22. In some cases, the housing 18 includes a recess 51 that complements the plate 50. In particular cases, the recess 51 extends along the sidewall 39. In further implementations, the recess 51 extends along the sidewall 39 and the rear surface 33. In certain implementations, the plate 50 includes at least one recess 53 (e.g., a slot, groove, opening, etc.) to enable coupling or decoupling of the plate 50 from the housing 18. In some example implementations, the mesh covered opening 52 is oversized relative to the second port 22.

In particular examples, as shown in FIG. 9, the second port 22 is located on a side surface (sidewall) 39 of the housing 18. However, the second port 22 can be located on the rear surface 33 according to various implementations. In such cases, the mesh covered opening 52 is located on the portion of the plate 50 that overlies the rear surface 33.

As discussed relative to other plates and covers herein, the plate 50 can define a gap between an inner surface of the plate and the outer surface 29 of the housing (e.g., at rear surface 33 and/or sidewall 39). This gap can act as an acoustic passage between the second port 22 and the recess 53 in the plate 50. Further, similar to other plates and covers described herein, the plate 50 can include a metal and be configured to couple/decouple with the housing 18 via magnetic attachment. For example, in cases where the plate 50 includes a metal, the earpiece 10c can further include a magnet 54 supported in the housing 18 that is configured to secure the plate 50 to earpiece 10c. In such cases, a magnetic tool (with greater relative magnetic strength) can be used to remove the plate 50 from the housing 18 when desired. The plate 50 can be secured to the housing 18 via the magnetic connection using magnet 54, which has sufficient strength to retain the plate 50 during use of the earpiece 10c.

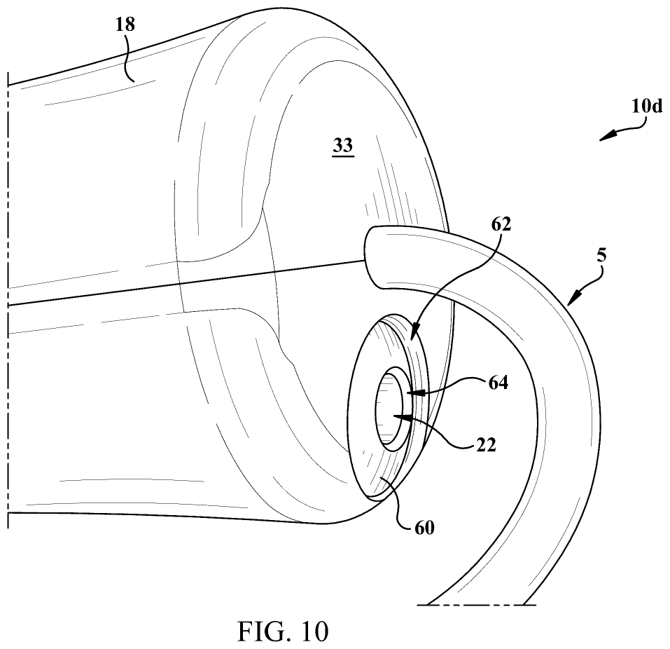

FIG. 10 illustrates another implementation of an earpiece 10d, including a configuration for protecting a second port 22 located on the rear surface 33 of the housing 18. In these cases, the second port 22 is located proximate the connection for wire 5, along the rear surface 33. Second port 22 can include a microphone (e.g., feedforward microphone) as described according to various implementations. In this embodiment, the second port 22 is protected by a removable wax guard 60. The wax guard 60 can inhibit debris from entering the second port 22. In one example, the wax guard 60 sits in a recess 62 formed in the housing 18, e.g., at the rear surface 33. In particular implementations, the wax guard 60 is secured in the recess via an interference fit. In certain implementations, the wax guard 60 includes an aperture 64 that acoustically couples the second port 22 with the space outside the housing 18. The wax guard 60 can be removed for cleaning and/or replacement.

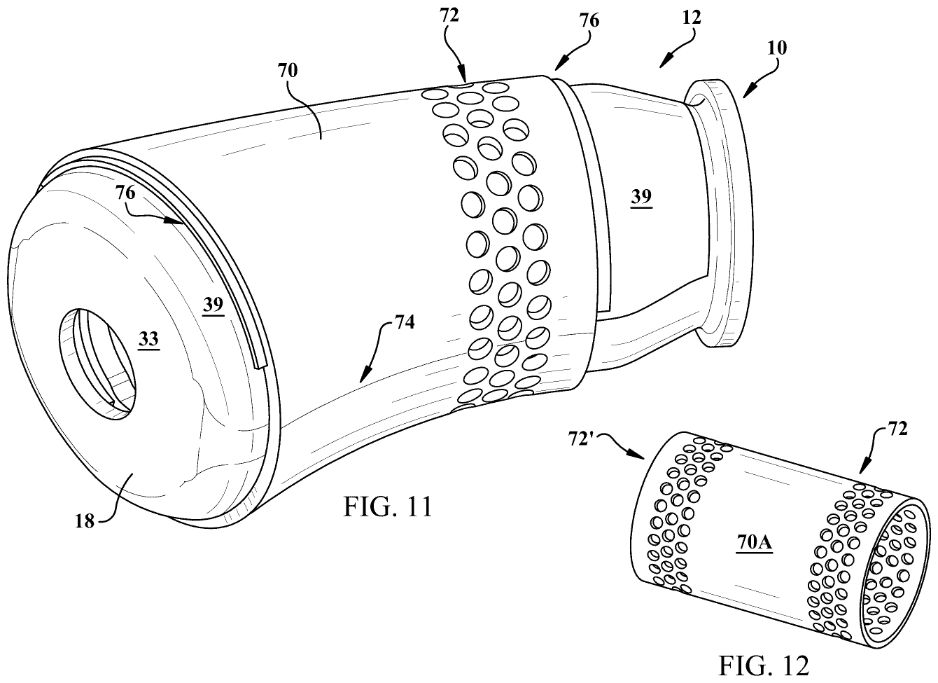

FIGS. 11 and 12 illustrate another implementation of a debris ingress mitigation apparatus, including the earpiece 10 (FIGS. 2-4) and distinct sleeves 70, 70A for protecting ports according to various implementations. It is understood that the sleeves 70, 70A can be used to protect ports in any of the earpieces described herein. In this example, a sleeve 70 at least partially surrounds the housing 18 to inhibit debris from entering the port(s) 16 and/or 22. In certain cases, the sleeve 70 extends along a length of the housing 18, e.g., along sidewalls 39. In various implementations, the sleeve 70 is formed of a compliant material, and can be coupled and/or decoupled by sliding the sleeve 70 axially relative to the housing 18. In some examples, the compliant material includes silicone. In certain cases, the sleeve 70 has a thickness of less than approximately 0.2 millimeters (mm) to approximately 0.6 mm. In a particular example, the sleeve 70 has a thickness of approximately 0.4 mm. In various implementations, the thickness of sleeve 70 is such that it does not interfere with the fit of the earpiece 10 in the ear of the user.

In particular implementations, the sleeve 70 includes a plurality of apertures 72 for acoustically coupling the first port 16 and/or the second port 22 with the space outside the housing 18. In one example, e.g., as shown in sleeve 70A in FIG. 12, the sleeve 70A can include two distinct sets of apertures 72, 72′ for respectively aligning with the first port 16 and the second port 22. In certain aspects, the apertures 72, 72′ are misaligned with the respective ports 16, 22.

In particular implementations, the sleeve 70 includes at least one alignment feature 74 for circumferentially aligning the sleeve 70 to the first port 16 and/or the second port 22. In some examples, the alignment feature 74 includes a ridge, a line, or another delineation that enables a user to efficiently align the sleeve 70 in the desired orientation relative to the housing 18. In further implementations, the housing 18 includes an axial alignment feature 76 for aligning and/or retaining the sleeve 70 axially against the housing 18. In some of these cases, the axial alignment feature 76 includes a ridge or protrusion on the housing 18 that prevents axial movement (e.g., sliding) of the sleeve 70.

As described herein, the various disclosed implementations can beneficially mitigate debris ingress in earpieces. In particular, the various disclosed implementations can beneficially mitigate debris ingress in behind-the-ear (BTE) or receiver-in-canal (RIC) earpieces such as hearing aids. The debris ingress protection features can enhance device performance, mitigate undesirable acoustic artefacts, and improve the user experience. Further, the debris ingress protection features disclosed according to various implementations can reduce the need for maintenance of the audio devices (e.g., hearing aids), and/or provide an efficient mechanism for users to maintain their hearing aids. The debris ingress protection features can be efficiently removed for maintenance and/or replacement, and during use, can be configured to prevent debris such as dust, dirt, and wax from entering ports in an earpiece.

It is understood that the audio device 2 (FIG. 1) and earpieces shown and described herein, in addition to microphones, can include additional sensors (or alternative sensors) in one of the modules, and can be configured to provide a sensor input to the audio device 2. In certain cases, the sensor(s) can include one or more of: a physiological sensor such as a heart rate monitor, a motion sensor such as an inertial measurement unit (IMU), an acoustic sensor such as an additional or alternative microphone, an environmental sensor such as a humidity or moisture sensor, a strain sensor such as a strain gauge, etc.

As noted herein the hearing aids and other audio devices disclosed herein can include one or more circuit components for performing processes according to various implementations. In certain cases, the electronics in audio device 2 includes a control circuit coupled with a processor and/or logic engine for adjusting a gain on one or more signals for producing an acoustic output. In some particular cases, a control circuit is contained in one or both earpieces in a headset, and receives commands from a logic engine for performing functions described herein. In additional cases, a logic engine is located remotely relative to earpieces in the hearing aid, e.g., in a connected smart devices such as a smart phone, smart watch, wearable smart device, etc., or in a cloud-based logic engine that is accessible via communications components at the hearing aid (not shown).

The controller(s) in the audio device 2 can execute instructions (e.g., software), including instructions stored in a memory or in a secondary storage device (e.g., a mass storage device). The controller(s) in the audio device 2 may be implemented as a chipset of chips that include separate and multiple analog and digital processors. The controllers in audio device 2 may provide, for example, for coordination of other components in the audio device 2, such as control of user interfaces, applications run by additional electronics in the audio device 2, and network communication by the audio device 2. The controller in the audio device 2 may manage communication with a user through a connected display and/or a conventional user input interface.

In various implementations, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

The term “approximately” as used with respect to values herein can allot for a nominal variation from absolute values, e.g., of several percent or less. Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, smoothing, and/or selecting from a plurality of values. Unless expressly limited by its context, the term “obtaining” is used to indicate any of its ordinary meanings, such as calculating, deriving, receiving (e.g., from an external device), and/or retrieving (e.g., from an array of storage elements). Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Any incorporation by reference of a portion of a document shall also be understood to incorporate definitions of terms or variables that are referenced within the portion, where such definitions appear elsewhere in the document, as well as any figures referenced in the incorporated portion.

Elements of figures are shown and described as discrete elements in a block diagram. These may be implemented as one or more of analog circuitry or digital circuitry. Alternatively, or additionally, they may be implemented with one or more microprocessors executing software instructions. The software instructions can include digital signal processing instructions. Operations may be performed by analog circuitry or by a microprocessor executing software that performs the equivalent of the analog operation. Signal lines may be implemented as discrete analog or digital signal lines, as a discrete digital signal line with appropriate signal processing that is able to process separate signals, and/or as elements of a wireless communication system.

Other embodiments not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

We claim:

1. An earpiece comprising:
an electro-acoustic transducer;
a housing supporting the electro-acoustic transducer such that the housing and the electro-acoustic transducer together define a first acoustic volume, wherein the housing defines a nozzle with an acoustic passage coupled with the first acoustic volume;
a first port coupling the first acoustic volume to a space outside the housing;
a second port coupling a microphone supported in the housing to the space outside the housing; and
an ear tip supported on the nozzle and configured to form a tight acoustic seal with a user's ear canal when the earpiece is worn, the ear tip comprising an extension member extending over the first port to inhibit debris from entering the first port.

2. The earpiece of claim 1, wherein the extension member includes at least one aperture that acoustically couples the first port with the space outside the housing,
wherein the extension member includes a plurality of apertures,
wherein at least one of the plurality of apertures is offset from the first port, and
wherein the offset aperture mitigates debris entering the first port.

3. The earpiece of claim 1, wherein the extension member is integral with the ear tip.

4. The earpiece of claim 1, wherein the extension member includes at least one tab contacting an outer surface of the housing to create an acoustic passage between the extension member and the housing, and either:
(a) the at least one tab extends from an inner surface of the extension member to contact the outer surface of the housing, or
(b) the acoustic passage between the extension member and the housing maintains an acoustic coupling between the first acoustic volume and the space outside the housing.

5. The earpiece of claim 1, wherein the ear tip is removable from the housing.

6. The earpiece of claim 1, wherein the microphone includes a feedforward microphone acoustically coupled with the second port, wherein the second port is located on a rear surface of the housing.

7. The earpiece of claim 6, further comprising:
wiring extending from the rear surface of the housing for connecting with a behind-the-ear module of an audio device that includes the earpiece; and
a cover over the second port to inhibit debris from entering the second port,
wherein the cover includes at least one aperture that acoustically couples the second port with the space outside the housing,
wherein at least one aperture in the cover is offset from the second port, wherein the offset aperture mitigates debris entering the second acoustic volume.

8. The earpiece of claim 1, wherein the housing includes a recess along a rear surface thereof, wherein the cover complements the recess along the rear surface,
wherein the cover is removably coupled with the rear surface at the recess.

9. The earpiece of claim 8, further comprising:
a first magnet in the housing,
wherein the cover includes a metal that is retained by a magnetic force from the first magnet, wherein the cover is removable by a tool including a second magnet having a greater magnetic strength than a magnetic strength of the first magnet.

10. An earpiece comprising:
an electro-acoustic transducer;
a housing supporting the electro-acoustic transducer such that the housing and the electro-acoustic transducer together define a first acoustic volume,
a first port coupling the first acoustic volume to a space outside the housing;
a second port coupling a microphone supported in the housing to the space outside the housing; and
a plate extending along the housing, the plate including a mesh covered opening positioned over the first port to inhibit debris from entering the first port.

11. The earpiece of claim 10, further comprising a recess in a sidewall of the housing, the recess complementing the plate.

12. The earpiece of claim 10, wherein the mesh covered opening is oversized relative to the first port.

13. The earpiece of claim 10, wherein the plate includes a metal and the earpiece further includes at least one magnet within the housing for retaining the metal plate with a magnetic force,
wherein the plate is removable by a tool having an additional magnet having a greater magnetic strength than a magnetic strength of the at least one magnet in the housing.

14. The earpiece of claim 10, wherein the plate:
i) includes at least one recess to enable at least one of coupling or decoupling of the plate from the housing,
ii) defines a radial gap between an inner surface of the plate and an outer surface of the housing, the radial gap acting as an acoustic passage between the first port and the at least one recess, or
iii) is removably coupled with the housing.

15. The earpiece of claim 10, wherein the mesh covered port includes a mesh with a Rayl value of approximately 6, enabling approximate acoustic transparency while blocking debris.

16. The earpiece of claim 10, wherein the microphone includes a feedforward microphone acoustically coupled with the second port, wherein the second port is located on a rear surface of the housing.

17. An earpiece comprising:
an electro-acoustic transducer;
a housing supporting the electro-acoustic transducer such that the housing and the electro-acoustic transducer together define a first acoustic volume,
a first port coupling the first acoustic volume to a space outside the housing;
a second port coupling a microphone supported in the housing to the space outside the housing; and
a plate extending along the housing, the plate including a mesh covered opening positioned over the second port to inhibit debris from entering the second port.

18. The earpiece of claim 17, further comprising a recess in a sidewall of the housing, the recess complementing the plate,
wherein the mesh covered opening is oversized relative to the second port.

19. The earpiece of claim 17, wherein the plate includes a metal and the earpiece further comprises at least one magnet within the housing for retaining the metal plate with a magnetic force,
wherein the plate is removable by a tool, and wherein the tool includes an additional magnet having a greater magnetic strength than a magnetic strength of the at least one magnet in the housing.

20. The earpiece of claim 17, wherein the plate:
i) includes at least one recess to enable at least one of coupling or decoupling of the plate from the housing,
ii) defines a gap between an inner surface of the plate and an outer surface of the housing, the gap acting as an acoustic passage between the second port and the at least one recess, or
iii) is removably coupled with the housing; and
wherein the mesh covered port includes a mesh with a Rayl value of approximately 6, wherein the Rayl value enables approximate acoustic transparency while blocking debris.
